(19) United States
(12) Patent Application Publication
(10) Pub. No.: US 2024/0011525 A1
(43) Pub. Date: Jan. 11, 2024

(54) PRESS ROLL APPARATUS

(71) Applicants: TOYOTA JIDOSHA KABUSHIKI KAISHA, Toyota-shi Aichi-ken (JP); Primearth EV Energy Co., Ltd., KOSAI SHIZUOKA (JP); Prime Planet Energy & Solutions, Inc., Chuo-ku Tokyo (JP)

(72) Inventors: Taichi URAKAMI, Nissin-shi Aichi-ken (JP); Seiji ISHIZU, Toyota-shi Aichi-ken (JP); Kazutoshi IWATA, Ichinomiya-shi Aichi-ken (JP); Masakazu UMEHARA, Toyota-shi Aichi-ken (JP); Shingo MORI, Kurokawa-gun Miyagi-ken (JP); Naoya Kishimoto, Nagoya-shi Aichi-ken (JP)

(73) Assignees: TOYOTA JIDOSHA KABUSHIKI KAISHA, Toyota-shi Aichi-ken (JP); Primearth EV Energy Co., Ltd., KOSAI SHIZUOKA (JP); Prime Planet Energy & Solutions, Inc., Chuo-ku Tokyo (JP)

(21) Appl. No.: 18/214,727

(22) Filed: Jun. 27, 2023

(30) Foreign Application Priority Data
Jul. 6, 2022 (JP) 2022-109134

(51) Int. Cl. F16C 13/02; B21B 31/07

(52) U.S. Cl. CPC F16C 13/02; B21B 31/078

(57) ABSTRACT

In a press roll apparatus, bearing portions rotatably support end portions on both sides of a pair of press roll portions, respectively. Each of the bearing portions includes a bearing body portion, a rolling bearing, and a pair of oil seal portions. The bearing body portion has an annular shape, and the press roll portion is inserted. The rolling bearing is positioned on the side of the press roll portion inserted into the bearing body portion as viewed from the bearing body portion, and rotatably supports the press roll portion. The rolling bearing is coated with lubricant. The oil seal portions are positioned on both sides in the first direction as viewed from the rolling bearing. The oil seal portions are connected to the bearing body portion. The oil seal portions are positioned so as to be spaced from the press roll portion inserted into the bearing body portion.

### CROSS-REFERENCE TO RELATED APPLICATION

This application claims priority to Japanese Patent Application No. 2022-109134 filed on Jul. 6, 2022, incorporated herein by reference in its entirety.

### BACKGROUND

### 1. Technical Field

The present disclosure relates to a press roll apparatus.

### 2. Description of Related Art

Japanese Unexamined Patent Application Publication No. 2001-303470 discloses a conventional press roll apparatus.

### SUMMARY

In the conventional press roll apparatus, a rolling bearing is sometimes provided in a bearing portion. The rolling bearing rotatably supports a press roll body that rotates, and is coated with lubricant. The bearing portion further includes an oil seal member for sealing the lubricant. The oil seal member slidably contacts with the press roll body that rotates. It is possible to avoid the lubricant from leaking to the exterior of the bearing portion. However, the contact between the oil seal member and the press roll body can abrade the press roll body, and can generate a foreign substance.

The present disclosure has been made in view of the above problem, and has an object to provide a press roll apparatus that can avoid generation of a foreign substance.

A press roll apparatus according to the present disclosure includes a pair of press roll portions and a plurality of bearing portions. Each of the pair of press roll portions extends in a first direction. The pair of press roll portions is positioned so as to face each other in a second direction orthogonal to the first direction. The plurality of bearing portions rotatably supports end portions on both sides of the pair of press roll portions, respectively. Each of the plurality of bearing portions includes a bearing body portion, a rolling bearing, and a pair of oil seal portions. The bearing body portion has an annular shape, and the press roll portion is inserted into the bearing body portion. The rolling bearing is positioned on the side of the press roll portion inserted into the bearing body portion as viewed from the bearing body portion, and rotatably supports the press roll portion. The rolling bearing is coated with lubricant. The pair of oil seal portions is positioned on both sides in the first direction as viewed from the rolling bearing. The pair of oil seal portions is connected to the bearing body portion. The pair of oil seal portions is positioned so as to be spaced from the press roll portion inserted into the bearing body portion.

With the above configuration, the press roll portions are not abraded by the contact with the oil seal portions. Therefore, it is possible to avoid generation of a foreign substance due to the abrasion of the press roll portions.

With the present disclosure, it is possible to provide a press roll apparatus that can avoid generation of a foreign substance.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view showing a press roll apparatus according to an embodiment of the present disclosure;

FIG. 2 is a sectional view of the press roll apparatus in FIG. 1 as viewed from a II-II line arrow direction;

FIG. 3 is a partial enlarged sectional view showing a region III in FIG. 2;

FIG. 4 is a partial enlarged sectional view showing a region IV in FIG. 3;

FIG. 5 is a graph showing a measured result of the thickness of a workpiece compressed using the press roll apparatus according to the embodiment of the present disclosure;

FIG. 6 is a sectional view showing a press roll apparatus according to a comparative example;

FIG. 7 is a graph showing the thickness of a workpiece compressed using the press roll apparatus according to the comparative example; and

FIG. 8 is a schematic sectional view showing a part of the press roll apparatus according to the comparative example and a workpiece at the end of compression.

### DETAILED DESCRIPTION OF EMBODIMENTS

A press roll apparatus according to an embodiment of the present disclosure will be described below. In the following description about the embodiment, identical or equivalent portions in the drawings are denoted by identical reference characters, and descriptions thereof are not repeated.

The press roll apparatus according to the embodiment of the present disclosure, specifically, is used for the compression of an electrode material, in a source process for an electric storage device. The electric storage device is a secondary battery as an example, is more specifically a lithium-ion battery (LiB), and is further specifically a lithium-ion battery that is equipped in an electrified vehicle. The electrode material is constituted by a current collector sheet as a core material, such as a metal foil, and an active material formed on the surface of the current collector sheet. The active material is disposed on the current collector sheet, by coating the current collector sheet with active material paste by a coater and then drying the current collector sheet.

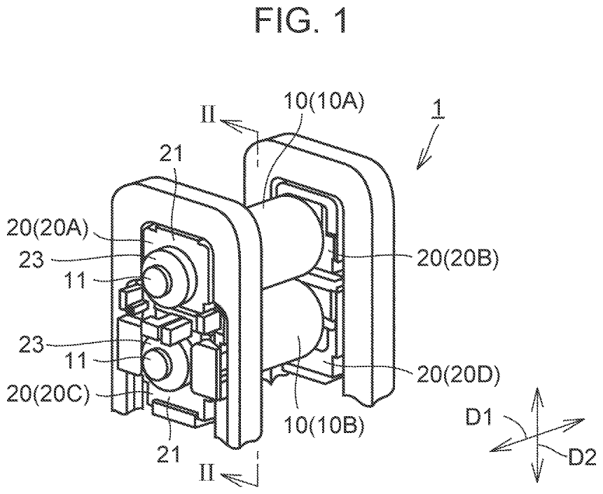

FIG. 1 is a perspective view showing the press roll apparatus according to the embodiment of the present disclosure. As shown in FIG. 1, a press roll apparatus 1 according to the embodiment of the present disclosure includes a pair of press roll portions 10 and a plurality of bearing portions 20.

Each of the pair of press roll portions 10 extends in a first direction D1. The pair of press roll portions 10 is positioned so as to face each other in a second direction D2 orthogonal to the first direction D1. The second direction D2, specifically, is a direction parallel to the vertical direction, but may be a direction crossing the vertical direction. The pair of press roll portions 10 is constituted by a first press roll portion 10A positioned on an upper side in the vertical direction and a second press roll portions 10B positioned on a lower side.

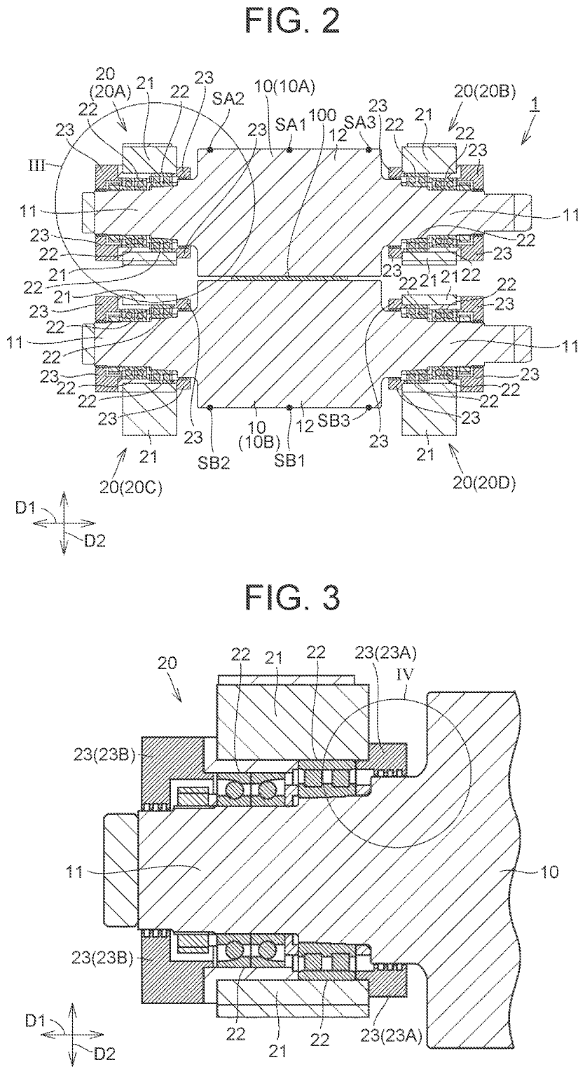

FIG. 2 is a sectional view of the press roll apparatus in FIG. 1 as viewed from a II-II line arrow direction. As shown in FIG. 1 and FIG. 2, each of the pair of press roll portions 10 includes a pair of end portions 11 and a central column portion 12 positioned between the two end portions 11 in the first direction D1. In other words, the pair of end portions 11 extend from both sides of the central column portion 12 in the first direction D1, respectively. The press roll portion 10 is supported at the end portions 11 on both sides. At least one of the end portions 11 on both sides is connected to a drive unit (not illustrated) such as a motor. The one of the end portions 11 on both sides is rotated by the drive unit, such that the axial direction of the central axis is the first direction D1. The central column portion 12 rotates with the rotation of the one of the end portions 11 on both sides.

A workpiece 100 comes in between the press roll portions 10 each of which rotates (specifically, between the central column portion 12 of the first press roll portion 10A and the central column portion 12 of the second press roll portion 10B). Thereby, the workpiece 100 is compressed in the second direction D2. The workpiece 100, specifically, is the above-described electrode material.

Generally, in the case where the workpiece 100 is an electrode material, the product tolerance of the thickness of the electrode material compressed by the press roll apparatus 1 is required to be several microns or less. Therefore, it is important that the press roll portions 10 are accurately molded. Furthermore, it is important that the press roll portions 10 are not deformed during the compression of the electrode material.

The plurality of bearing portions 20 rotatably supports the end portions 11 on both sides of the pair of press roll portions, respectively. Specifically, the plurality of bearing portions 20 is constituted by a first bearing portion 20A and a second bearing portion 20B that rotatably support the end portions 11 on both sides of the first press roll portion 10A and a third bearing portion 20C and a fourth bearing portion 20D that rotatably support the end portions 11 on both sides of the second press roll portion 10B. In the following description about the bearing portion 20, only the first bearing portion 20A in the drawings is sometimes mentioned as the bearing portion 20, but such descriptions are not limited to the first bearing portion 20A.

FIG. 3 is a partial enlarged sectional view showing a region III in FIG. 2. As shown in FIG. 2 and FIG. 3, each of the plurality of bearing portions 20 includes a bearing body portion 21, rolling bearings 22, and a pair of oil seal portions 23.

The bearing body portion 21 has an annular shape, and the press roll portion 10 is inserted into the bearing body portion 21. The inner circumferential surface of the bearing body portion 21 has a circular shape, and the outer circumferential surface of the bearing body portion 21 has a roughly rectangular shape, as viewed from the first direction D1. The rolling bearing 22 is positioned on the side of the press roll portion 10 inserted into the bearing body portion 21 as viewed from the bearing body portion 21, and rotatably supports the press roll portion 10. The bearing portion 20 includes a plurality of rolling bearings 22, but the bearing portion 20 only needs to include one or more rolling bearings 22. The rolling bearing 22 is coated with lubricant (grease).

The pair of oil seal portions 23 is positioned on both sides in the first direction D1 as viewed from the rolling bearing 22. The pair of oil seal portions 23 is connected to the bearing body portion 21. The oil seal portions 23 avoid the lubricant applied on the rolling bearing 22 from leaking to the exterior of the bearing portion 20. The pair of oil seal portions 23 is constituted by a first oil seal portion 23A positioned on the central column portion 12 side of the press roll portion 10 as viewed from the rolling bearing 22 and a second oil seal portion 23B positioned on the opposite side of the central column portion 12 side of the press roll portion 10 as viewed from the rolling bearing 22.

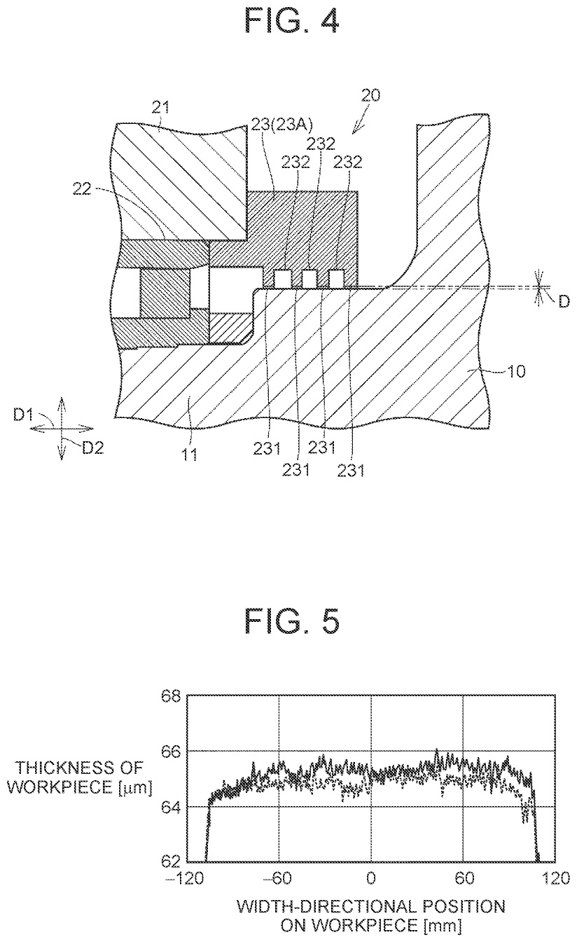

FIG. 4 is a partial enlarged sectional view showing a region IV in FIG. 3. As shown in FIG. 3 and FIG. 4, the pair of oil seal portions 23 is positioned so as to be spaced from the press roll portion 10 inserted into the bearing body portion 21. Specifically, the oil seal portion 23 is positioned so as to be spaced from the end portion 11 of the press roll portion 10 that faces an inner surface of the oil seal portion 23.

Each of the pair of oil seal portions 23 includes an inner circumferential surface portion 231 and a plurality of groove portions 232. The inner circumferential surface portion 231 is a portion of the oil seal portion 23 that is closest to the press roll portion 10. The inner circumferential surface portion 231 faces the press roll portion 10 in a radial direction about the rotation axis of the press roll portion 10. For example, a spaced distance D between the inner circumferential surface portion 231 and the press roll portion 10 is approximately 0.25 mm. For example, the number of groove portions 232 in one oil seal portion 23 is three. A portion that is of the end portion 11 of the press roll portion 10 and that faces the oil seal portion 23 (specifically, the inner circumferential surface portion 231) extends parallel to the first direction D1.

The plurality of groove portions 232 is positioned so as to be arrayed while being spaced from each other in the first direction D1. Each of the plurality of groove portions 232 is formed on the inner circumferential surface portion 231 toward the outside in the radial direction about the rotation axis of the corresponding press roll portion 10. The groove portions 232 extend in a circumferential direction about the rotation axis of the press roll portion 10. In each of the groove portions 232, the size (width size) in the first direction D1 is approximately 3 mm, for example. In each of the groove portions 232, the size (depth size) in the radial direction about the rotation axis of the corresponding press roll portion 10 is approximately 4 mm.

Although FIG. 4 shows the inner circumferential surface portion 231 and the groove portions 232 in the first oil seal portion 23A, the second oil seal portion 23B also includes the same inner circumferential surface portion 231 and groove portions 232 as the first oil seal portion 23A. However, the first oil seal portion 23A and the second oil seal portion 23B are different from each other in the distance from the rotation-axial center of the corresponding press roll portion 10 to the inner circumferential surface portion 231.

In the embodiment, the oil seal portion 23 has a so-called concentric groove shape as described above. However, the oil seal portion 23 is not limited to the above-described shape, as long as the oil seal portion 23 is positioned so as to be spaced from the press roll portion 10 inserted into the bearing body portion 21. For example, the shape of the oil seal portion 23 may be a so-called linear gap type or thread groove type. Further, the portion that is of the end portion 11 of the press roll portion 10 and that faces the oil seal portion 23 may have a shape that appropriately corresponds to the shape of the oil seal portion 23. The oil seal portion 23 may seal the lubricant by having a so-called slinger shape or oil thrower shape. Furthermore, the oil seal portion 23 may realize the seal of the lubricant by a so-called labyrinth shape, together with the end portion 11 of the press roll portion 10. The specific shape of the labyrinth shape is not particularly limited. Examples of the labyrinth shape include a radial labyrinth shape, an axial labyrinth shape and an alignment labyrinth shape.

Next, experimental examples when the workpiece is compressed using the press roll apparatus 1 according to the embodiment and a press roll apparatus according to a comparative example described later will be described. The following experimental examples show experimental results when the workpiece is an electrode material and one workpiece is continuously compressed while being conveyed at a constant speed in a conveyance direction orthogonal to both the first direction D1 and the second direction D2.

An experimental example for the press roll apparatus 1 according to the embodiment will be described. In the experimental example, the thickness of the workpiece 100 compressed using the press roll apparatus 1 according to the embodiment was measured. The measurement of the thickness of the workpiece 100 was performed for a spot of the workpiece 100 that was compressed at the start of the compression and a spot of the workpiece 100 that was compressed at the end of the compression (about 40 minutes after the start of the compression). In the experimental example, the conveyance speed of the workpiece 100 in the conveyance direction was 100 m/minute, and therefore the compression start spot and compression end spot of the workpieces 100 were approximately 4000 m away from each other. Further, the thickness of each spot was measured over the whole of the workpiece 100 in a width direction of the workpiece 100. The width direction of the workpiece 100 is a direction that corresponds to the first direction D1.

FIG. 5 is a graph showing a measured result of the thickness of the workpiece compressed using the press roll apparatus according to the embodiment of the present disclosure. In FIG. 5, the abscissa axis indicates measurement positions on the workpiece 100 in the width direction of the workpiece 100 after the compression, and the ordinate axis indicates the thickness of the workpiece 100 at each measurement position. The origin of the abscissa axis is a central position in the width direction of the workpiece 100. Further, a measured result for the spot compressed at the start of the compression is shown by a broken line, and a measured result for the spot compressed at the end of the compression is shown by a solid line.

As shown in FIG. 5, at both of the spot compressed at the start of the compression and the spot compressed at the end of the compression, the thickness of the workpiece 100 was approximately 64 μm or more and 66 μm or less, at measurement positions where the thickness of the workpiece 100 was 64 μm or more (that is, at a portion where the active material was sufficiently disposed on the current collector sheet). Thus, it was found that the thickness of the workpiece 100 after the compression was almost the same between the compression start spot and the compression end spot in the press roll apparatus 1 according to the embodiment.

Furthermore, at the time of the above-described compression, temperatures at some positions on the press roll apparatus 1 were also measured. As shown in FIG. 2, the measurement positions were positions on the circumferential surface of the central column portion 12 of the first press roll portion 10A, positions on the circumferential surface of the central column portion 12 of the second press roll portion 10B, the first bearing portion 20A, the second bearing portion 20B, the third bearing portion 20C, and the fourth bearing portion 20D. The positions on the circumferential surface of the central column portion 12 of the first press roll portion 10A were a center surface (first center surface SA1) in the first direction D1 and surfaces (first end portion vicinity surfaces SA2, SA3) at vicinities of both end edges in the first direction D1. The positions on the circumferential surface of the central column portion 12 of the second press roll portion 10B were a center surface (second center surface SB1) in the first direction D1 and surfaces (second end portion vicinity surfaces SB2, SB3) at vicinities of both end edges in the first direction D1. For the measurement of the temperatures of the respective bearing portions 20, specifically, the temperatures of the bearing body portions 21 were measured. Each temperature measurement was performed at the start of the compression of the workpiece 100 and at the end of the compression of the workpiece 100 (about 40 minutes after the start of the compression). Table 1 shows a start temperature To, an end temperature T, and a temperature change ΔT(=T−To) from the start of the compression to the end of the compression, for each measurement position.

TABLE 1

| | Start temperature | End temperature | Temperature change |
|---|---|---|---|
| Measurement position | To [° C.] | T [° C.] | ΔT(= T − To) [° C.] |
| First center surface SA1 | 24.0 | 26.1 | 2.1 |
| First end portion vicinity surface | 24.0 | 26.2 | 2.2 |
| SA2 | | | |
| First end portion vicinity surface | 24.0 | 26.3 | 2.3 |
| SA3 | | | |
| Second center surface SB1 | 23.9 | 26.0 | 2.1 |
| Second end portion vicinity | 23.9 | 26.3 | 2.4 |
| surface SB2 | | | |
| Second end portion vicinity | 23.9 | 26.2 | 2.3 |
| surface SB3 | | | |
| First bearing portion 20A | 24.0 | 25.9 | 1.9 |
| Second bearing portion 20B | 24.1 | 26.2 | 2.1 |
| Third bearing portion 20C | 24.0 | 26.4 | 2.4 |
| Fourth bearing portion 20D | 24.0 | 26.2 | 2.2 |

As shown in Table 1, the temperature change ΔT at each measurement position was 1.9° C. to 2.4° C. It is thought that the temperature change was caused by the heat generation of the rolling bearings 22.

Further, the differences between the temperature change ΔT of the first center surface SA1 and the respective temperature changes ΔT of the first end portion vicinity surfaces SA2, SA3 were 0.1° C. and 0.2° C., and the differences between the temperature change ΔT of the second center surface SB1 and the respective temperature changes ΔT of the second end portion vicinity surfaces SB2, SB3 were 0.3° C. and 0.2° C. In this way, the difference between the temperature change ΔT of the center surface in the first direction D1 and the temperature change ΔT of the end portion vicinity surface in the first direction D1 on the circumferential surface of the central column portion 12 of the press roll portion 10 was 0.1° C. to 0.3° C., and had relatively small values.

After the above experiment, the intervals between the press roll portions 10 and the bearing portions 20 were visually checked from the outside. As a result, generation of a foreign substance and leakage of the lubricant to the exterior were not recognized.

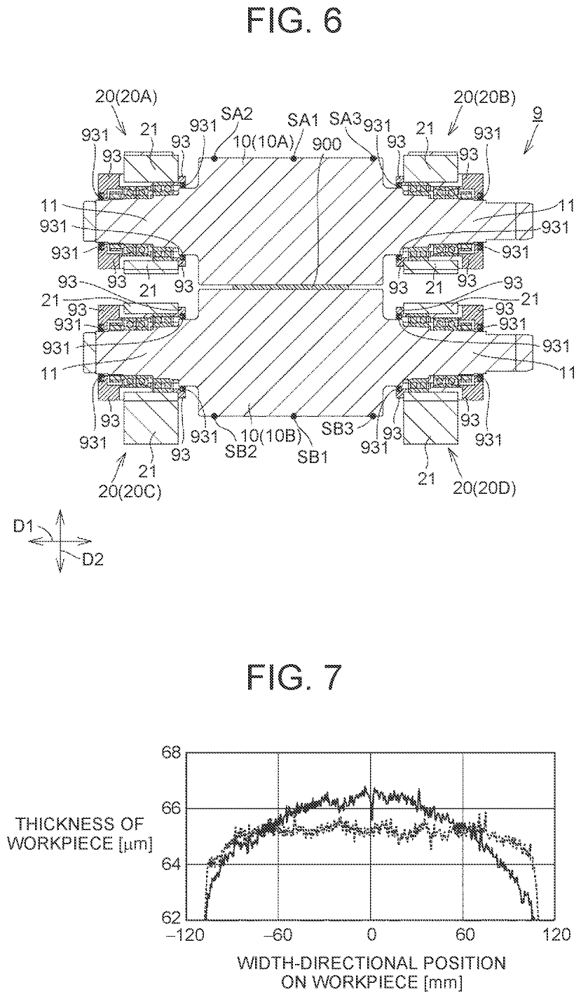

Next, an experimental example for the press roll apparatus according to the comparative example will be described. FIG. 6 is a sectional view showing the press roll apparatus according to the comparative example. As shown in FIG. 6, the press roll apparatus 9 according to the comparative example is different from the press roll apparatus 1 according to the embodiment of the present disclosure, in that a pair of oil seal portions 93 is positioned so as to contact with the press roll portion 10 inserted into the bearing body portion 21. The oil seal portions 93 of the press roll apparatus 9 according to the comparative example include lip seals 931 that contact with the press roll portion. The lip seals 931 slidably contact with the press roll portion 10 that rotates.

Also in the comparative example, the thickness of the workpiece 100 compressed using the press roll apparatus 9 according to the comparative example was measured, similarly to the experimental example for the press roll apparatus 1 according to the embodiment. FIG. 7 is a graph showing the thickness of the workpiece compressed using the press roll apparatus according to the comparative example. FIG. 7 shows a measured result of the thickness of a compressed workpiece 900. Specifically, a measured result for a spot of the workpiece 900 that was compressed at the start of the compression is shown by a broken line, and a measured result for a spot that was compressed at the end of the compression is shown by a solid line.

As shown in FIG. 7, at the compression start spot, the thickness of the workpiece 900 was approximately 64 μm or more and 66 μm or less, at measurement positions where the thickness of the workpiece 900 was 64 μm or more. However, at the compression end spot, a portion where the thickness of the workpiece 900 was more than 66 μm at measurement positions where the thickness of the workpiece 900 was 64 μm or more was recognized at a width-directional center of the workpiece 900.

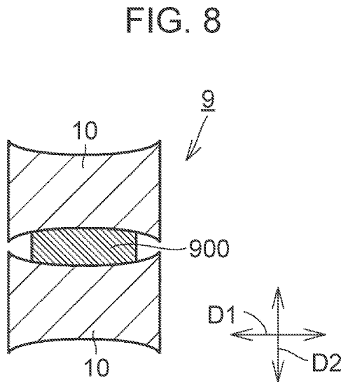

FIG. 8 is a schematic sectional view showing a part of the press roll apparatus according to the comparative example and the workpiece at the end of the compression. It is thought that the shape of the press roll portion 10 was deformed into a drum shape during the compression in the press roll apparatus 9 according to the comparative example as shown in FIG. 8.

Furthermore, in the comparative example, temperatures at some positions on the press roll apparatus 9 were also measured similarly to the experimental example for the press roll apparatus 1 according to the embodiment. Table 2 shows the start temperature To, the end temperature T, and the temperature change ΔT(=T−To) from the start of the compression to the end of the compression, for each measurement position.

TABLE 2

| | Start temperature | End temperature | Temperature change |
|---|---|---|---|
| Measurement position | To [° C.] | T [° C.] | ΔT(= T − To) [° C.] |
| First center surface SA1 | 21.2 | 26.5 | 5.3 |
| First end portion vicinity surface | 21.2 | 28.0 | 6.8 |
| SA2 | | | |
| First end position vicinity | 21.2 | 27.0 | 5.8 |
| surface SA3 | | | |
| Second center surface SB1 | 21.2 | 25.3 | 4.1 |
| Second end portion vicinity | 21.2 | 27.0 | 5.8 |
| surface SB2 | | | |
| Second end portion vicinity | 21.2 | 26.7 | 5.5 |
| surface SB3 | | | |
| First bearing portion 20A | 21.3 | 26.6 | 5.3 |
| Second bearing portion 20B | 21.3 | 25.1 | 3.8 |
| Third bearing portion 20C | 21.3 | 26.2 | 4.9 |
| Fourth bearing portion 20D | 21.3 | 25.2 | 3.9 |

As shown in Table 2, the temperature change ΔT at each measurement position was 3.8° C. to 6.8° C. It is thought that the temperature change was caused by the heat generation of the rolling bearing 22 and the friction heat between the lip seals 931 and the press roll portions 10.

Further, the differences between the temperature change ΔT of the first center surface SA1 and the respective temperature changes ΔT of the first end portion vicinity surfaces SA2, SA3 were 1.5° C. and 0.5° C., and the differences between the temperature change ΔT of the second center surface SB1 and the respective temperature changes ΔT of the second end portion vicinity surfaces SB2, SB3 were 1.7° C. and 1.4° C. In this way, the difference between the temperature change ΔT of the center surface in the first direction D1 and the temperature change ΔT of the end portion vicinity surface in the first direction D1 on the circumferential surface of the central column portion 12 of the press roll portion 10 was 0.5° C. to 1.7° C., and had relatively large values.

As shown in the above-described experimental examples, the uniformity of the thickness of the workpiece compressed by the press roll apparatus 1 according to the embodiment was higher than the uniformity of the thickness of the workpiece compressed by the press roll apparatus 9 according to the comparative example.

Moreover, in the press roll apparatus 1 according to the embodiment, the temperature change ΔT at each measurement position was smaller than in the press roll apparatus 9 according to the comparative example. Therefore, it is thought that the temperature change ΔT in the press roll apparatus 1 according to the embodiment did not cause such a thermal deformation of the press roll portion 10 that the thickness of the workpiece 100 was influenced. Further, in the press roll apparatus 9 according to the comparative example, the difference between the temperature change ΔT of the center surface in the first direction D1 and the temperature change ΔT of the end portion vicinity surface in the first direction D1 on the circumferential surface of the central column portion 12 of the press roll portion 10 was larger than in the press roll apparatus 1 according to the embodiment. Therefore, it is thought that the temperature change caused the deformation (that is, thermal deformation) of the press roll portion 10 shown in FIG. 8 and this deformation caused the thickness difference in the width direction of the workpiece 900 shown in FIG. 7, in the comparative example.

From the results of the above experimental examples, it is thought that the friction heat between the press roll portion 10 and the oil seal portions 23 was not generated and therefore the rise in the temperature of the press roll portion 10 during the compression was relatively restrained in the press roll apparatus 1 according to the embodiment of the present disclosure in which the pair of oil seal portions 23 were positioned so as to be spaced from the press roll portions 10 inserted into the bearing body portion 21. Accordingly, it is thought that the thermal deformation of the press roll portion 10 was relatively restrained. Consequently, the press roll apparatus 1 according to the embodiment can be suitably used as a compression apparatus for the electrode material, because the uniformity of the thickness of the compressed workpiece 100 is kept until the end of the compression.

In the press roll apparatus 9 according to the comparative example, as described above, the lip seals 931 slidably contact with the press roll portion 10 that rotates. Therefore, the press roll portion 10 is abraded at spots that contact with the lip seals 931. In the case where the surface of the press roll portion 10 is composed of metal, a foreign metal substance can be generated by the abrasion of the press roll portion 10.

On the other hand, in the press roll apparatus 1 according to the embodiment of the present disclosure, as described above, the pair of oil seal portions 23 is positioned so as to be spaced from the press roll portion 10 inserted into the bearing body portion 21. With the configuration, the press roll portions 10 are not abraded by the contact with the oil seal portions 23. Therefore, it is possible to avoid generation of a foreign substance due to the abrasion of the press roll portions 10. Furthermore, in the case where the press roll portion 10 is composed of metal, it is possible to avoid the generation of the foreign metal substance, which can cause the short circuit of the electric storage device. Therefore, the press roll apparatus 1 can be suitably used as a compression apparatus for the electrode material.

It should be understood that the embodiment disclosed herein is an example and is not limiting in all respects. It is intended that the scope of the present disclosure is shown not by the above description but by the claims and includes all alterations in a meaning and range that are equivalent to the claims.

What is claimed is:

1. A press roll apparatus comprising:
a pair of press roll portions each of which extends in a first direction, the pair of press roll portions being positioned so as to face each other in a second direction orthogonal to the first direction; and
a plurality of bearing portions that rotatably supports end portions on both sides of the pair of press roll portions, respectively, wherein:
each of the plurality of bearing portions includes
an annular bearing body portion into which the press roll portion is inserted;
a rolling bearing that is positioned on a side of the press roll portion inserted into the bearing body portion as viewed from the bearing body portion, that rotatably supports the press roll portion, and that is coated with lubricant, and
a pair of oil seal portions that is positioned on both sides in the first direction as viewed from the rolling bearing and that is connected to the bearing body portion; and
the pair of oil seal portions is positioned so as to be spaced from the press roll portion inserted into the bearing body portion.
